(19) United States
(12) Patent Application Publication
(10) Pub. No.: US 2026/0222316 A1
(43) Pub. Date: Jul. 30, 2026

(54) A SYSTEM AND METHODS FOR ADAPTIVE NEGOTIATION STRATEGIES GENERATION IN EDGE CLOUD

(71) Applicant: Telefonaktiebolaget LM Ericsson (publ), Stockholm (SE)

(72) Inventors: Mbarka SOUALHIA, Laval (CA); Carla MOURADIAN, Montreal (CA)

(21) Appl. No.: 19/146,541

(22) PCT Filed: Jan. 12, 2023
(86) PCT No.: PCT/IB2023/050291

§ 371 Date: Jul. 9, 2025

(51) Int. Cl. H04L 41/16; H04L 41/08; H04L 41/14

(52) U.S. Cl. CPC H04L 41/16; H04L 41/08; H04L 41/14

(57) ABSTRACT

A method in an edge node (EN) to negotiate with other ENs includes determining assets to be negotiated in a negotiation request (NR), the NR having an indication of the assets to be negotiated; responsive to strategies similar to the NR stored in a repository, mapping NR data to a MDP model to identify a current state, possible actions, and corresponding rewards; responsive to no negotiation strategies found: collecting on-the-fly data about EN assets status, constraints, and events to generate a list of negotiation strategies that reflect a status of the EN based on RL techniques to create a new MDP model; generating a list of negotiation strategies based on criteria; finding an optimum strategy therefrom; identifying negotiation details including a negotiation type and style to define a negotiation contract with other ENs; publishing the negotiation contract using the type and style and sending NRs to selected ENs.

### TECHNICAL FIELD

The present disclosure relates generally to communications, and more particularly to communication methods and related devices and nodes supporting wireless communications.

### BACKGROUND

Edge computing has tremendously changed the way cloud applications are running and managed by extending the assets (e.g., resources, capabilities, data, knowledge, etc.) closer to the end-users. Since most of the edge nodes are resource-constrained, the accommodation of every application within edge environments can be very challenging. Hence, we need to efficiently manage assets (e.g., resources, capabilities, data, trained model, knowledge, etc.) in the edge to identify which set of assets and which edge nodes should be deployed to run the applications. It becomes even more complicated when the application characteristics are dynamically changing. Therefore, there is a need to manage the sharing of the available assets across the different edge nodes to work together and coordinate to fulfill the applications requirements. Existing solutions negotiate a single type of asset which is mainly the edge resources (e.g., CPU, memory, etc.). However, edge nodes are characterized by different features and behaviors, and they are heterogeneous (e.g., capabilities, resources, network interfaces, hardware configurations). In addition, edge applications may require more assets than the computational resources to be fully executed, for example, they may need a trained model at another edge, a built knowledge from other edge nodes, etc.

### Published Technology

Few authors discussed negotiation-based cloud systems. Authors in the nonpatent literature (NPL) by Shojaiemehr B, Rahmani A M, and Qader N N titled “Cloud computing service negotiation: a systematic review” in Comp Standards & Interfaces. 2018; 55:196-206 study the existing works on cloud computing service negotiation frameworks, techniques, protocols, and strategies. The goal is to understand open issues and challenges in providing negotiation systems in the cloud. Authors in the NPL document titled “A real-world inspired multi-strategy based negotiating system for cloud service market (by Adabi, S., Mosadeghi, M. & Yazdani, S, in J Cloud Comp 7, 17 (20180) propose a cloud negotiation system to achieve a better utility in negotiation-based cloud resource allocation. The proposed system supports different negotiation strategies such as relaxing strategy, pressuring strategy, and normal concession strategy.

U.S. Pat. No. 9,274,917: This patent claims a method to measure the performance of a composite cloud service in a federated cloud environment. The system determines if the performance indicates breaching of a performance policy and accordingly identifies the failed cloud service(s). The system then may decide to migrate or replicate the failed cloud service on another cloud resource. The system may also negotiate with other negotiation services to select an optimal cloud service with respect to Quality of Service (QOS) demands in the federated cloud environment.

U.S. Pat. No. 6,842,899 B2: This patent presents a system to allow negotiating allocation resources among autonomous agents in a communication network composed of a plurality of computers connected to the network. It describes a method, where each agent receives a graph that contains information about the resources it has and what task(s) it may perform. Each agent uses this graph to identify the required resource(s) to achieve the task(s) that it has to perform and then it can negotiate with each other for the resources needed to carry out their task(s).

U.S. Patent Publication 2021/0021431 A1: This patent application publication proposes a system to engage edge nodes in a peer-to-peer resources bidding process. Particularly, it presents a method to configure a network interface to allow the first node to participate in a peer-to-peer resource bidding process with a plurality of other nodes of the network. The requesting node can accept one of the offers or send an updated request for bids if the received offers are not satisfying. There can be multiple rounds of requests for bids and offers/counteroffers.

In the NPL document titled “When deep reinforcement learning meets federated learning: Intelligent multi timescale resource management for multiaccess edge computing by Yu Shuai et al., the authors propose computation offloading decisions and resource allocation strategies in multi-access edge computing in 5G ultradense network” in IEEE Internet of Things Journal, 8.4 (2020:2238-2251. Their primary objective is to minimize the total offloading delay and network resource usage by jointly optimizing computation offloading, resource allocation, and service caching placement. Reinforcement learning and a blockchain-based approach are used for application partitioning, resource allocation, and service caching placement. Federated learning is used for training deep learning agents in a distributed manner to make offloading decisions with the goal to protect personal data privacy in the model training process. The offloading happens to a nearby edge server or a mobile device and is triggered only due to the resource limitation of a given edge node. Thus, only computational assets are considered. For instance, an edge node might decide to offload a computation-intensive task/sub-task due to its limited computational capabilities. Other assets that can be exchanged are not considered. Edge applications may require more assets than only computational resources to be fully executed, for example, they may need a trained model at another edge, a built knowledge from other edge nodes, etc. Also, the heterogeneity is considered only in terms of computation resources (e.g., CPU, GPU) and communication links (e.g., cellular and D2D). Heterogeneity can be also in terms of hardware configuration, resources, and network interfaces, which should be considered during the negotiation process.

Although they describe how such edge nodes communicate with each other in order to offload tasks, however, this can be seen as a single negotiation strategy, where whenever a node receives a task, if it cannot process it then it offloads it. The only decision to be made is where to offload, which is a well-known problem, and many algorithms exist to solve it. This decision is made based on the available resources of other nodes only, and not on what the destination node can provide back to the requesting node as a response.

### SUMMARY

There currently exist certain challenge(s).

In existing solutions, only one type of asset (e.g., capabilities, resources) is usually negotiated and shared, i.e., cloud resources (e.g., CPU, memory). However, unlike cloud, edge nodes are heterogeneous in terms of capabilities, resources, network interfaces, hardware configurations, different response times, etc. Accordingly, edge nodes might need and share different assets from each other.

Existing solutions use a single type of negotiation strategy: if the node has the requested resource, then it accepts the bidding process. However, edge nodes might have different behaviors and characteristics, hence, there might be a need to follow different negotiation strategies or a combination of two or more strategies that are more adaptive to the current status of the edge cloud.

Although it is known that agents can negotiate with each other and exchange proposals and counterproposals, to the best of our knowledge, there exists no work that generates adaptive on-the-fly negotiation strategies that is suitable considering the status of the edge nodes, and their information such as capabilities, heterogeneity (not only in terms of computational resources), and assets (not only in terms of computational capabilities).

Certain aspects of the disclosure and their embodiments may provide solutions to these or other challenges. Considering the above facts, it is of interest to design an automated system/architecture to dynamically negotiate and manage edge cloud assets (e.g., resources, capabilities, data, knowledge, etc.) on the fly according to the application requirements and the assets possessed by edge nodes.

According to some embodiments, a method in an edge node of a network to negotiate with other edge nodes includes responsive to the edge node determining that the edge node is unable to fulfill requirements of a service request received, determining (1001) assets to be negotiated in a negotiation request based on a service request received, the negotiation request having an indication of the assets to be negotiated to process the negotiation request. The method further includes responsive to previously discovered or executed negotiation strategies previously discovered or executed stored in a negotiation strategy repository that are similar to the negotiation request, mapping the negotiation request to negotiation strategies previously discovered or executed by: mapping data about the negotiation request to a Markovian Decision Process, MDP, model associated with the previously discovered or executed negotiation strategies to identify a current state and possible actions to be applied and the corresponding rewards according to the MDP model. The method further includes responsive to no negotiation strategies similar to the negotiation request being found: collecting on-the-fly data from the edge node about status of edge node assets, constraints to be considered, and events experienced by the edge node for generating a list of negotiation strategies that would reflect a current status of the edge node based on using reinforcement learning techniques to model the data as a MDP and solving the MDP to create a new MDP model, and mapping data about the received negotiation request to the new MDP model.

The method further includes generating a list of possible negotiation strategies to be applied based on negotiation criteria, the list of possible strategies including a current state of the edge node and one or more sets of an action, a next state, a reward, and a Q-value. The method further includes training a reinforcement learning, RL, agent to find an optimum negotiation strategy from the list of possible negotiation strategies. The method further includes identifying negotiation details and defined criteria including defining a type of negotiation and a negotiation style to define a negotiation contract with the other edge nodes. The method further includes selecting edge nodes to initiate a process of negotiation following the defined criteria. The method further includes publishing the negotiation contract using the type of negotiation and the negotiation style and sending negotiation requests to the edge nodes selected.

Analogous edge nodes, computer program, and computer program products are also provided.

Certain embodiments may provide one or more of the following technical advantage(s). The system and associated methods may automatically manage and negotiate different types of assets (e.g., resources, data, trained model, knowledge, etc.) between edge nodes allowing efficient cooperation between edge cloud nodes. The various embodiments enable efficient management of assets among edge nodes and allows edge nodes to transparently exchange assets while handling their heterogeneity.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrate an overview of different components that enable dynamical management and negotiation of assets (e.g., resources, data, knowledge, etc.) between edge nodes to allow better cooperation between these nodes according to some embodiments;

FIG. 2 is a signalling diagram of components according to some embodiments;

FIG. 3 is a signaling diagram of a negotiation agent according to some embodiments;

FIG. 4 is a block diagram of a negotiator agent according to some embodiments;

FIG. 5 is an illustration of a Markov decision process model;

FIG. 6 is an illustration of an example of a RL Q-Table according to some embodiments;

FIG. 7 is an illustration of an example of negotiation according to some embodiments;

FIG. 8 is a block diagram illustrating a negotiation strategy realization according to some embodiments;

FIG. 9 is a signaling diagram illustrating examples of negotiations according to some embodiments;

FIGS. 10A-17 are flow charts illustrating operations of an edge node according to some embodiments of inventive concepts;

FIG. 18 is a block diagram of a communication system in accordance with some embodiments;

FIG. 19 is a block diagram of a user equipment in accordance with some embodiments

FIG. 20 is a block diagram of a network node in accordance with some embodiments;

FIG. 21 is a block diagram of a host computer communicating with a user equipment in accordance with some embodiments;

FIG. 22 is a block diagram of a virtualization environment in accordance with some embodiments; and

FIG. 23 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, although it is known that agents can negotiate with each other and exchange proposals and counterproposals, to the best of our knowledge, there exists no work that generates adaptive on-the-fly negotiation strategies that is suitable considering the status of the edge nodes, and their information such as capabilities, heterogeneity (not only in terms of computational resources), and assets (not only in terms of computational capabilities).

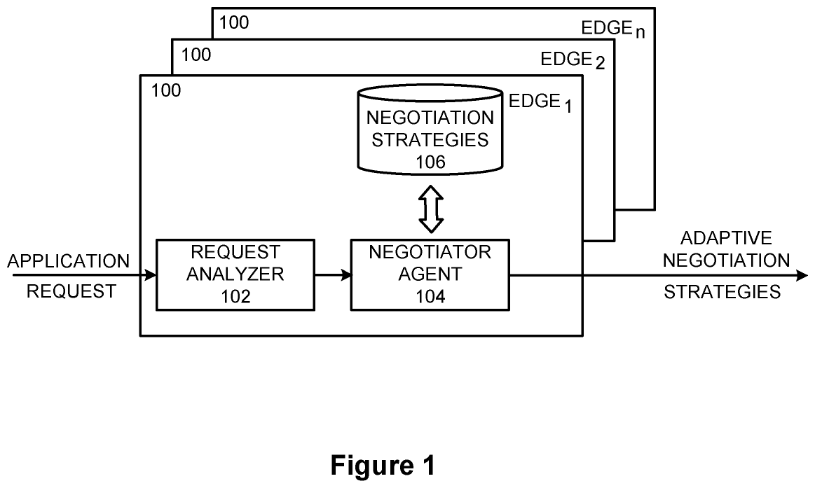

A system and methods that can automatically and dynamically generate negotiation strategies to manage the assets (e.g., resources, data, trained model, knowledge, etc.) on the fly between edge nodes shall now be described. The system and methods allow efficient cooperation between edge nodes to better utilize the different types of existing assets and fulfill the requirements of applications requests. The system can select negotiation and management strategies and adapt them, on the fly, to the status of the edge nodes and applications requirements. FIG. 1 presents an overview of the different components in the various embodiments that provides an ability to dynamically manage and negotiate assets (e.g., resources, data, knowledge, etc.) between edge nodes 100 to allow better cooperation between these nodes. Hence, it allows for improving the overall utilization of assets between edge nodes which can help avoid taking poor negotiation decisions. The input is an “Application Request,” and the output is a list of “adaptive Negotiation Strategies.” The various embodiments can be deployed and distributed across edge domains to ensure cooperative and coordinated management decisions. The system is composed of two main components that can be deployed on edge nodes 100:
1. The first component 102 is called a “Request Analyzer” represents an interface that receives and processes the received applications requests. It mainly checks whether the current edge node 100 can fulfill the requirements of the received service requests (e.g., availability of resources, knowledge, etc.). When the criterion is met, it executes the service request locally on the given edge node 100. If not, it triggers the “Negotiator Agent” to start negotiation with other edge nodes 100 to help in executing the received request.
2. The second component 104 is called a “Negotiator Agent” and it generates adaptive strategies for negotiation between edge nodes 100. It mainly builds a repository (Negotiation Strategies repository 106) of negotiation strategies using ML models based on information/events collected from the edge environment.
   The Negotiator Agent 104 establishes negotiation channels between edge nodes and precisely between their Negotiator Agents 104. It determines details of the negotiation contract (e.g., type, strategy, objective, etc.) based on the results obtained from the Request Analyzer 102 and a list of generated adaptive negotiation strategies. Then, it publishes this negotiation contract to other edge nodes 100.
   When receiving offers from other Negotiator Agents 104, the Negotiator Agent 104 evaluates their proposals and selects the optimal/acceptable one(s) and/or defines a counterproposal if needed. Next, it finalizes the negotiation agreement and notifies other agents from other edge nodes 100. Finally, it stores historical data about negotiation agreements and strategies in the Negotiation Strategies repository 106.

Users can access the services offered by applications deployed in edge-cloud domains and send their service requests using their equipment (mobile, smartwatch, laptop, etc.). Next, the received service requests will be analyzed by the Request Analyzer 102.

The Request Analyzer 102 is a communication component that receives, processes, and transmits information about the received application requests. First, it checks whether the edge node 100 fulfills the requirements of the received service request in terms of, for example, availability of resources, knowledge, etc.:
If it fulfills these requirements, it forwards the service request to the application manager and the resource manager to execute and manage the requested assets.
If not, it triggers the Negotiator Agent 104 to start negotiation with other edge nodes 100 to help in executing the received service request.

The negotiator agent 104 is an important component in our solution that establishes negotiation channels with other negotiator agents 104 from other edge nodes 100. First, the negotiator agent 104 defines the details of the negotiation contract (e.g., type, strategy, objective, etc.) using ML (machine learning) models and data collected from the edge nodes 100. It then publishes and sends these details to other negotiator agents 104. It also evaluates the received offers to select the optimal/acceptable proposal or determines a counterproposal if needed. Next, it finalizes the negotiation agreement and notifies other negotiator agents 104 from other edge nodes 100. In addition, it stores historical data about negotiation agreements and strategies in the negotiation strategies repository 106.

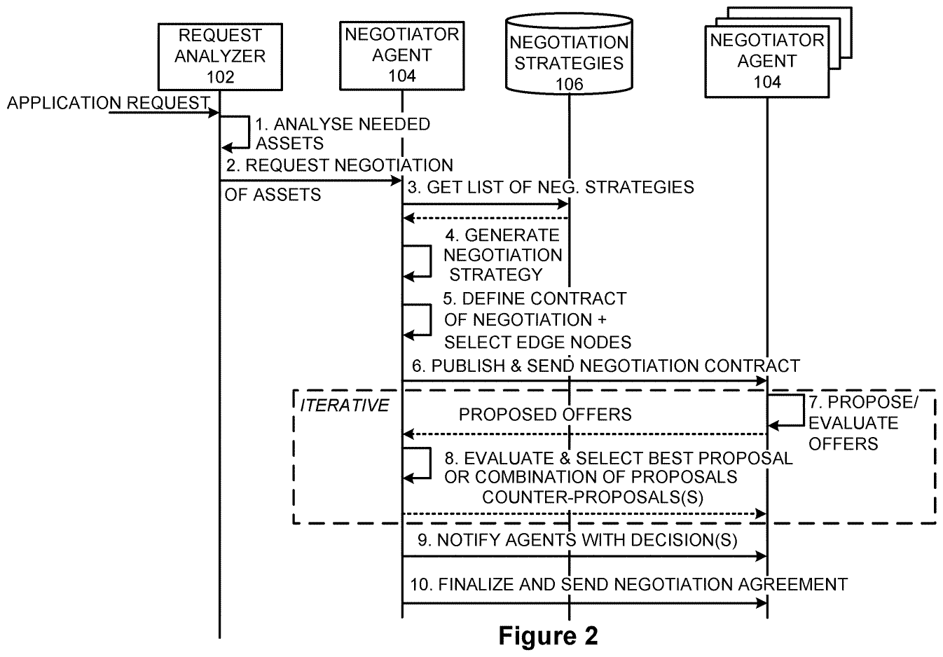

FIG. 2 depicts a signalling diagram that describes the operations followed by the request analyzer 102 and negotiator agents 104. The operations in FIG. 2 are:
1. Upon receiving the application request, the request analyzer 102 analyzes the available assets in the edge node 100 where the request was received and checks whether it maps the requested ones to fulfill the requirements of the received request. If yes, then, it sends the request to be executed.
2. When this edge node 100 does not fulfill the request requirements, the request analyzer 102 triggers the process of negotiation with other edge nodes 100. So, it sends information about the identified assets (to be negotiated to process the received requests) to the negotiator agent 104.
3. Next, the negotiator agent 102 maps the received request to the list of negotiation strategies previously discovered/executed, if found. This operation is important to identify a similar request(s) in the negotiation strategies repository 106 and determine some of the important criteria of negotiation and prioritize some of them if they were previously deployed given their success rate(s).
4. When no strategies were found (mapped to the received request), the negotiator agent 104 collects on-the-fly data from the edge node 100 about the status of its assets, and events (e.g., failure, performance degradation, etc.) and uses these data to generate an adaptive negotiation strategy that would reflect the current status of the edge node. To do so, the negotiator agent 104 uses reinforcement learning (RL) techniques to model the collected data as an MDP (Markovian Decision Process) and solve it using two possible existing algorithms that are Q_Learning and SARSA (see e.g., Csaba Szepesvari. Algorithms for Reinforcement Learning. Morgan and Claypool Publishers, 2010). Details about this step and the 2 algorithms will be provided hereinafter. Next, the negotiator agent 104 will generate a list of adaptive negotiation strategies to define the type of objective to follow when negotiating with other edge nodes 100.
5. Given the list of generated ML-based strategies, the negotiator agent 104 identifies details-criteria to define negotiation contracts with other edge nodes 100. For instance, it could define the type of negotiation (e.g., FIFO, timed, biding, etc.) and the style to follow when negotiating with other edge nodes 100 (e.g., competitive, cooperative, etc.). Next, the negotiator agent 104 determines the edge nodes 100 that could initiate the process of negotiation with them following the defined criteria. For example, it only selects the cooperative edge nodes 100 when the selected style is cooperative negotiation. This is to reduce the number of negotiation requests and their analysis time.
6. Next, the negotiator agent 104 publishes the negotiation contract (negotiation type+strategy) and sends negotiation requests to the selected edge nodes 100 previously selected.
7. The other negotiator agents 104, which will be referred to as offering agents 104, analyze the received negotiation requests. They analyze their available assets and the requested ones and map them to their (potential) needs. Next, they propose an offer for the received negotiation request and send back the proposed offers to the requesting negotiator agent 104.
8. The negotiator agent 104 receives the proposed offers and evaluates them with respect to the received application request(s) and checks whether the offered assets would fulfill the requirements of the application request(s). Next, the negotiator agent 104 selects the best/optimal one that defines the best/optimal proposal. In some scenarios, the negotiator agent 104 may select a combination of more than one proposal as the best/optimal proposal. Otherwise, the negotiator agent 104 could propose counterproposals and refine/change the received proposals. Note that operations 7 and 8 will be running iteratively until finding the best proposals or reaching a maximum negotiation timeout.
9. The negotiator agent 104 notifies the results of the negotiation with the selected edge nodes 100.
10. Then, the negotiator agent 104 finalizes the details of the negotiation agreement and sends it to the selected edge node(s) 100 to define the execution and the coordination plans among the edge nodes 100 defined in the negotiation agreement. Finally, the negotiator agent 104 stores the negotiation strategy results in the negotiation strategy repository 106.

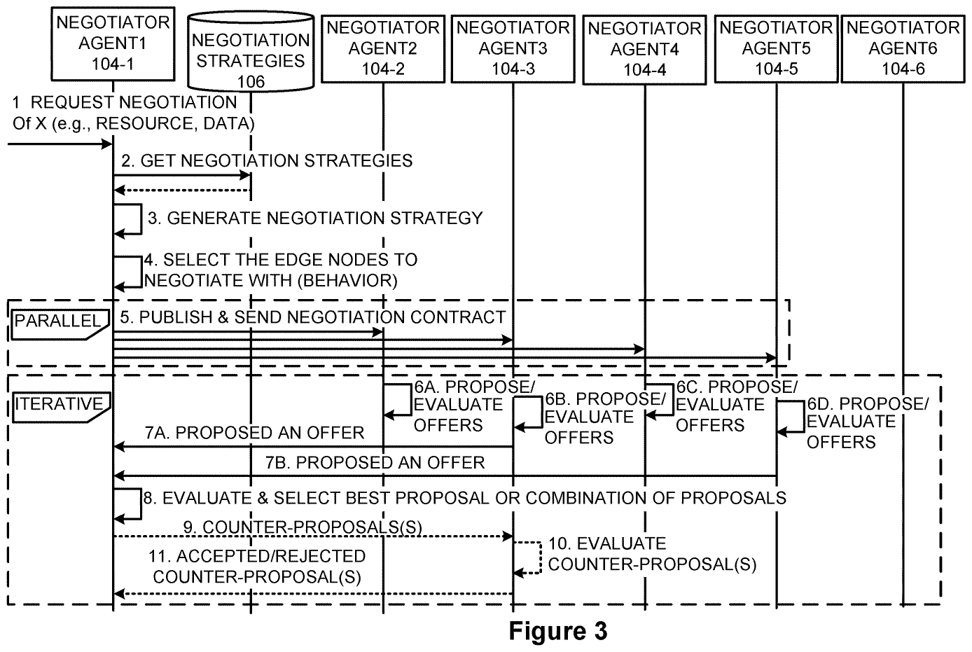

FIG. 3 depicts a signalling diagram of the negotiator agent 104 and presents the different steps followed for asking and offering during the negotiation. The operations in FIG. 3 are:
1. The negotiator agent 104-1 belonging to edge node 100-1 receives a negotiation request. This request includes the information on what to negotiate. In other terms, what the edge node 100-1 needs and what it can offer.
2. In this operation, the negotiator agent 104-1 gets a list of negotiation strategies, if found, that are similar to the received request, to save the execution time and find an appropriate negotiation strategy, from the negotiation strategies repository 106.
3. When no previous similar strategies were found, the negotiator agent 104-1 should generate a list of possible negotiation strategies using ML techniques. Note that a negotiation strategy includes a negotiation type and a negotiation style. A negotiation type indicates the type that a negotiation agent should follow during the decision-making process. It can follow a FIFO (first-in, first-out) order, a bidding strategy, or some other types. For negotiation styles, 5 styles could be used in the various embodiments, following human negotiation styles (see Understanding Negotiation Styles: https://trainingindustry.com/articles/leadership/understanding-negotiating-styles/); competing, avoiding, accommodating, compromising, and collaborating (see their description below). A selected negotiation strategy can rely on a single negotiation style or a combination of two or more negotiation styles. The five styles are:
   Competing: negotiators in this style are assertive, and tend to pursue their own concerns, sometimes at their counterpart's expense.
   Avoiding: negotiators in this style are generally less assertive. They stay neutral, objective, or leave the responsibility to their counterpart.
   Accommodating: negotiators in this style focus on maintaining relationships with others. They are most concerned with maintaining a good rapport and satisfying the needs of others.
   Compromising: negotiators in this style seek middle-ground solutions, which tends to end in moderate satisfaction of both parties' needs.
   Collaborating: negotiators in this style are often honest and communicative. They focus on finding creative solutions that fully satisfy the concerns of all parties.
4. The negotiator agent 104-1 then selects a negotiation strategy (type+style). This selection depends on the type of the application and the user. After selecting the negotiation strategy, the negotiator agent 104-1 selects the edge nodes 100 to negotiate with. The selection of the edge nodes 100 depends on the own behavior of Edge node 100-1 and the selected negotiation strategy.
5. In this operation, the negotiator agent 104-1 sends a call for proposals by publishing the details of its negotiation contract to the selected edge nodes 100. This negotiation contract includes information on what Edge node 100-1 needs and what Edge node 100-1 can offer.
6. In operations 6a to 6d, the corresponding negotiation agents 104-2 to 104-5 of the selected edge nodes 100 evaluate the details of the negotiation contract and generate proposals (if they have) based on the published negotiation contract and their assets. For example, if the negotiator agent 104-1 is requesting a specific amount of resources (e.g., CPU), the other negotiation agents 104-2 to 104-5 can predict their future resources need and accordingly evaluate and decide how much CPU they can offer at a specific time to Edge node 100-1.
7. In operation 7, the corresponding negotiator agents 104 send their proposals to negotiator agent 104-1. In the example of FIG. 3, it can be noticed that only negotiator agent 104-3 (i.e., operation 7a) and negotiator agent 104-5 (i.e., operation 7b) send proposals. This might mean that other edge nodes100 do not have the assets to satisfy Edge node 100-1 needs.
8. At this step, the negotiator agent 104-1 analyzes the received proposals with respect to its own satisfaction/requirements and makes a decision whether to accept, reject, or generate a counterproposal.
9. The negotiator agent 104-1 can propose a counterproposal to one or more edge nodes 100. Here, the negotiator agent 104-1 proposes a counterproposal to negotiator agent 104-3.
10. Similar to operation 6b, the negotiator agent 104-3 evaluates the counterproposal and decides whether to accept or reject the counterproposal with respect to its own requirements and assets.
11. The decision of whether to accept or reject the counterproposal from negotiator agent 104-1 is sent back to negotiator agent 104-1″.

It should be noted that operations 6 to 11 are performed iteratively until the negotiation between negotiator agent 104-1 and the other agents terminates. The termination can happen when the negotiator agent 104-1 accepts or rejects a proposal that meets its requirements. The acceptance or the rejection of a proposal can depend on the negotiation type, for instance, for the FIFO type, the negotiator agent 104-1 will accept the first proposal that meets its requirements.

Negotiation Strategies Generation using Reinforcement Learning

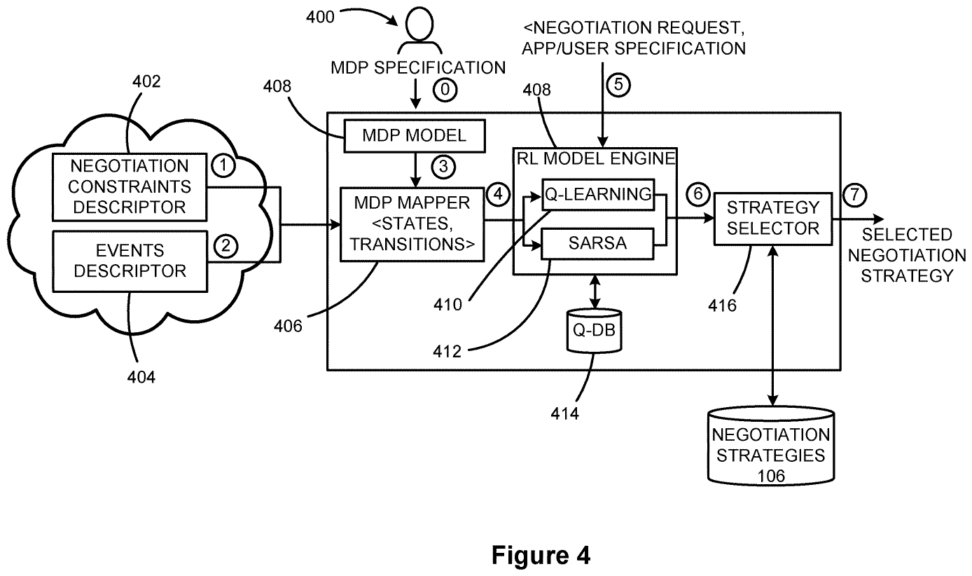

FIG. 4 presents a detailed description of the negotiator agent 104 to generate adaptive negotiation strategies using reinforcement learning (RL) techniques based on data collected from the edge environment.

To do so, in some embodiments, the decisions making at the negotiator agent 104 is modeled as a Markov Decision Process (MDP). The MDP presents a solution to systematically solve multiple-stage probabilistic decision-making problems where the behavior of the system depends on a random factor. To learn an MDP and find its optimal strategy, RL can be used to achieve such a goal. RL is a type of machine learning to learn how the environment is dynamically behaving by performing actions to maximize a cumulative reward function. Different RL algorithms exist in the literature, such as Q-Learning, and SARSA (State-Action-Reward-State-Action) (see e.g., Csaba Szepesvari. Algorithms for Reinforcement Learning. Morgan and Claypool Publishers, 2010).

To describe the inventive concepts, two RL algorithms to select the appropriate strategy to manage the received negotiation management request. Both Q-learning and SARSA algorithms learn Q values (in a format of Q-table) that are represented as ‘Qπ(s, a)’ that refers to the return value of the current state ‘s,’ applying action ‘a’ under strategy ‘π.’ Q-Learning is an off-policy RL algorithm that selects the strategy with maximum reward value while SARSA is an on-policy RL algorithm that selects the next state and action according to a random strategy.

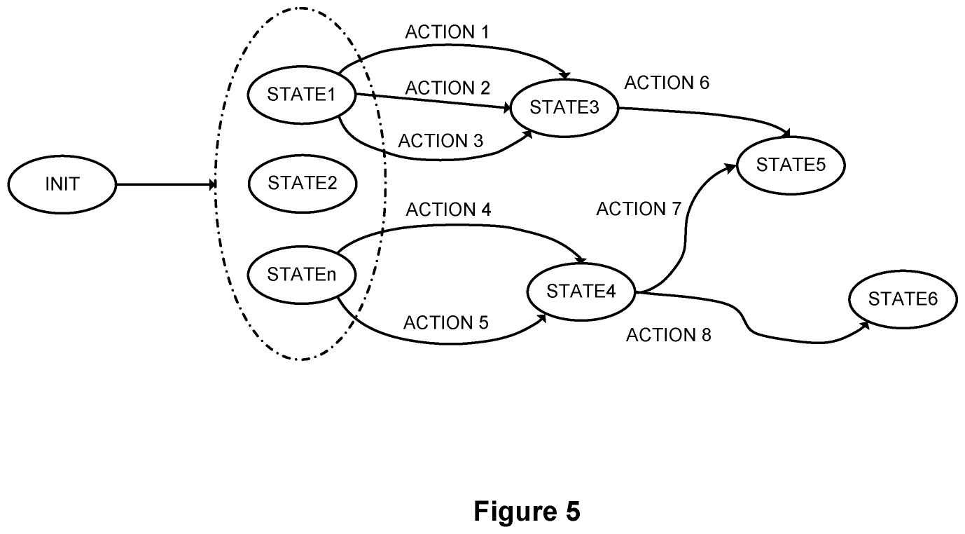

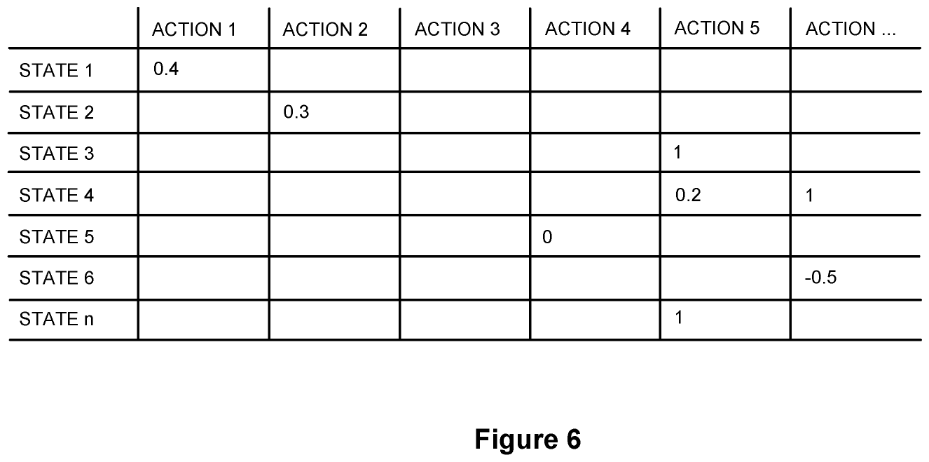

In the following, the different operations that can be followed by the negotiator agent 104 to generate adaptive negotiation strategies:
0—The user/cloud analyst 400 (i.e., the person managing the cloud-edge system) provides a description of the MDP specification including one or more of the following items: [number of states, states, possible actions, reward values, possible transitions].
1. Using the negotiation constraints descriptor 402, the negotiator agent 104 gets the description of constraints or requirements from the edge environment that should be considered while managing the received requests including: [overall utilization of resources, workload load rate, energy consumption rate, etc.].
2. Using the edge events descriptor 404, the negotiator agent 104 gets the description of events experienced by the edge domains to capture the different variations that could characterize the network, availability of resources, failure rate, workload variation, etc.
3. The MDP mapper 406 maps the input MDP specification 408 to the data collected from the cloud-edge system (description of the constraints and events in the cloud-edge), to discover the states and transitions to be used to train specific RL methods (Q-learning and SARSA) as shown in FIG. 5, which is an example of a Markov Decision Process Model.
4. The RL model engine 408 uses the input MDP data and offline data about negotiation requests to train Q-Learning 410 and SARSA 412 algorithms to get a Q-DataBase (Q-DB) 414. The Q-DB 414 stores the Q-table values obtained while training the RL models. An example of an RL Q-Table is presented in FIG. 6.
5. The negotiator agent 104 maps the data about the received negotiation request to the MDP model to identify its corresponding state (current state) and hence to identify the possible actions to be applied and the corresponding rewards according to the MDP description. The generated output here will be a list of possible strategies to be applied based on the negotiation criteria: [current state, {<action 1, next state 1, reward 1, Q-value1>, <action 2, next state 2, reward 2, Q-value 2>, . . . , <action n, next state n, reward n, Q-value n>}].
6. The strategy selector 416 analyzes the list of obtained strategies and their corresponding updates to the strategy that satisfies the negotiation criteria and the application and user specifications.
7. The strategy selector 416 identifies the candidate strategies that satisfy mostly the negotiation request and meet the identified edge constraints and events.

### Cloud Implementation—An Example of a Negotiator Agent

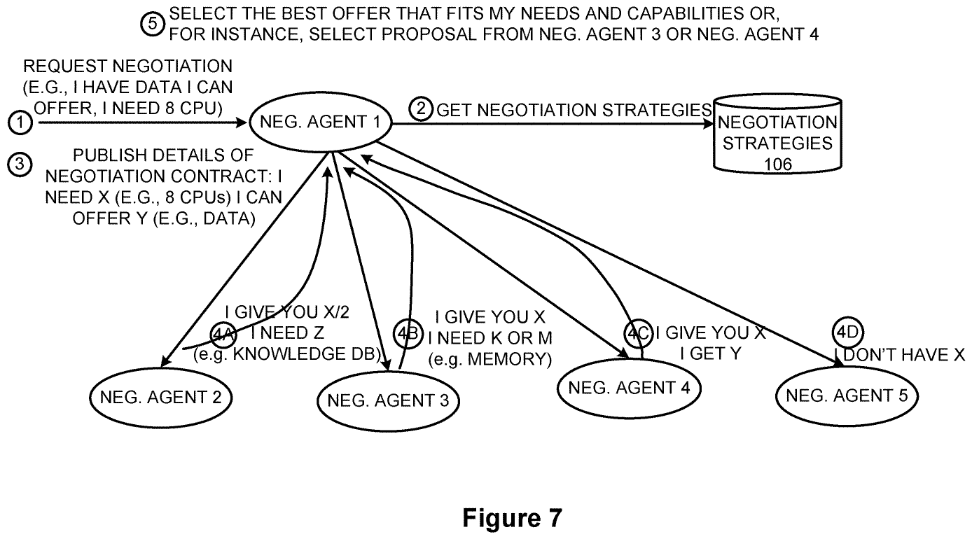

FIG. 7 illustrates an example of negotiation in a cloud implementation where the negotiation agents 104 are distributed in a cloud environment. It follows the same operations and logic followed in Error! Reference source not found. The operations of FIG. 7 are:
1. The negotiation agent 104-1 gets triggered to start a negotiation. This request includes what Edge node 101-1 needs and what it can offer. For instance, “I have specific data I can offer, I need a specific number of CPUs.”
2. Similar to the previous section, the negotiation agent 104-1 gets a list of negotiation strategies and selects the one to follow and utilize according to the application and the user type. For instance, the negotiation agent 104-1 may decide to follow an “accommodating” style and a “best fit” type. An accommodating style is followed when a negotiator is most concerned with maintaining a good rapport and satisfying the needs of the other parties. The best fit type is chosen when an application is not a time-critical one, accordingly, it can wait for all proposals to arrive and select the best one that meets the requirements of Edge node 100-1.
3. The negotiation agent 104-1 publishes the details of its negotiation contract: e.g., I need x (e.g., 8 CPUs) I can offer y (specific data).
4. In this step, each negotiation agent 104 evaluates the details in the negotiation contract and accordingly proposes an offer. Some examples are below:
   a. Negotiation agent 104-2 offers half the amount of the requested CPU and request capability z, e.g., knowledge database. The negotiation agent 104-2 might be following a competing negotiation style, where it tends to pursue its own concerns at its counterpart's expense.
   b. Negotiation agent 104-3 offers the requested amount of CPU; however, it requests k or m asset, e.g., memory resources. The negotiation agent 104-3 might be following a collaborating negotiation style, where such negotiators are most concerned with finding novel and creative solutions that fully satisfy the concerns of all parties.
   c. Negotiation agent 104-4 offers the requested amount of CPU and accepts the offered data by negotiation agent 104-1. The negotiation agent 104-4 might be following an accommodating negotiation style where it is concerned with maintaining relationships with other parties and satisfying their needs.
   d. Negotiation agent 104-5 decides to not propose any offer since it does not have the requested amount number of CPUs. The negotiation agent 104-5 might be following an avoiding negotiation style which means that it is less assertive and prefer to avoid stepping into or creating tension.
5. In this step, the negotiation agent 104-1 makes a decision and selects the best offer that fits its needs and capabilities. For instance, considering a “best fit” negotiation type and “accommodating” negotiation style, the negotiation agent 104-1 waits for all proposals to arrive and selects either the proposal of negotiation agent 104-3 (if negotiation agent 104-1 also has k or m) or the proposal of negotiation agent 104-4.

### Negotiation Contract/Strategy Realization

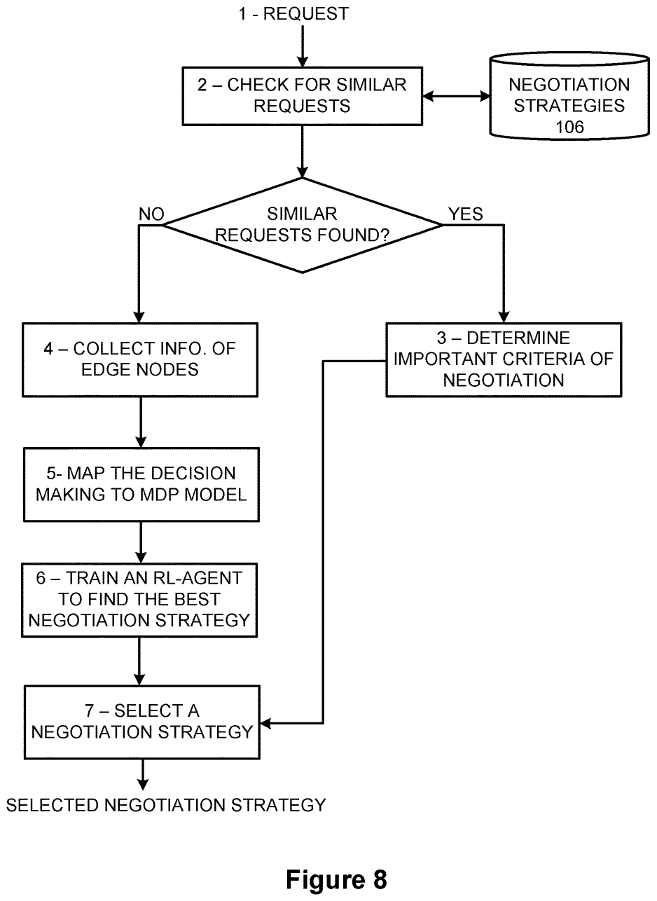

The flowchart in FIG. 8 represents the operations followed to generate adaptive negotiation contracts. For clarity purposes, the flowchart focusses on the negotiation strategies generation, which is part of the negotiation contract.
1. The input request includes application requirements, application constraints, and user specifications.
2. The negotiation agent 104 first checks if previous similar requests exist in the negotiation strategies repository 106.
3. If previous similar requests are found, the negotiation agent 104 identifies some criteria of negotiation (type+strategy) if they were previously deployed given their success rate, to utilize and prioritize them in the next steps.
4. If previous similar requests do not exist, then the negotiation agent 104 proceeds with generating new negotiation strategies. The negotiation agent 104 first collects information on edge nodes including their constraints such as overall utilization of resources, energy consumption rate, etc., and their hardware configurations, and network interfaces, to ensure compatibility. The negotiation agent 104 also collects event information experienced by edge nodes 100 such as workload variation, failure rates, etc.
5. Next, the negotiation agent 104 generates negotiation strategies. To do so, the decision-making is modeled as Markov Decision Process (MDP) and an RL-based algorithm is trained and used to make the decision as described above. In order to generate a negotiation strategy, an MDP is modeled. The MDP includes edge information such as constraints (e.g., utilization of resources), edge events (e.g., failure rates, workload variations), hardware configuration, etc. as states. In one embodiment, an action is represented by selecting a negotiation strategy. In another embodiment, an action can represent selecting a negotiation type. The reward function of the MDP model is used to guide the RL agent to find an optimal negotiation strategy. The action leading to a better objective function is associated with a larger reward. In order to find the best negotiation strategy, the objective function represented by the reward is calculated by summing the application requirements satisfaction rate, application constraints satisfaction rate, and the user requirements satisfaction rate. If previous similar requests are found, then the identified criteria from similar requests are also considered in the calculation of the reward function, meaning, that actions matching the defined negotiation criteria from previous requests are associated with a higher reward.
6. An RL-based algorithm is trained, e.g., Q-Learning to get a Q-Database for selecting a negotiation strategy considering different states. The Q-Database represents a list of possible strategies (actions) to be selected from with different Q-values (different rewards according to their level of satisfaction with the application requirements, application constraints, and user specifications). More details about this operation are provided above. Next, the negotiation agent 104, according to the current state of the environment, identifies possible actions to be applied (i.e., possible negotiation strategies to select from) and their corresponding reward values.
7. The negotiation agent 104 then selects the action (the negotiation strategy) with the highest reward. And finally, the negotiation agent 104 adds the new strategy with its specifications to the Negotiation Strategies Repository, which will be updated with a success rate after the request is processed.

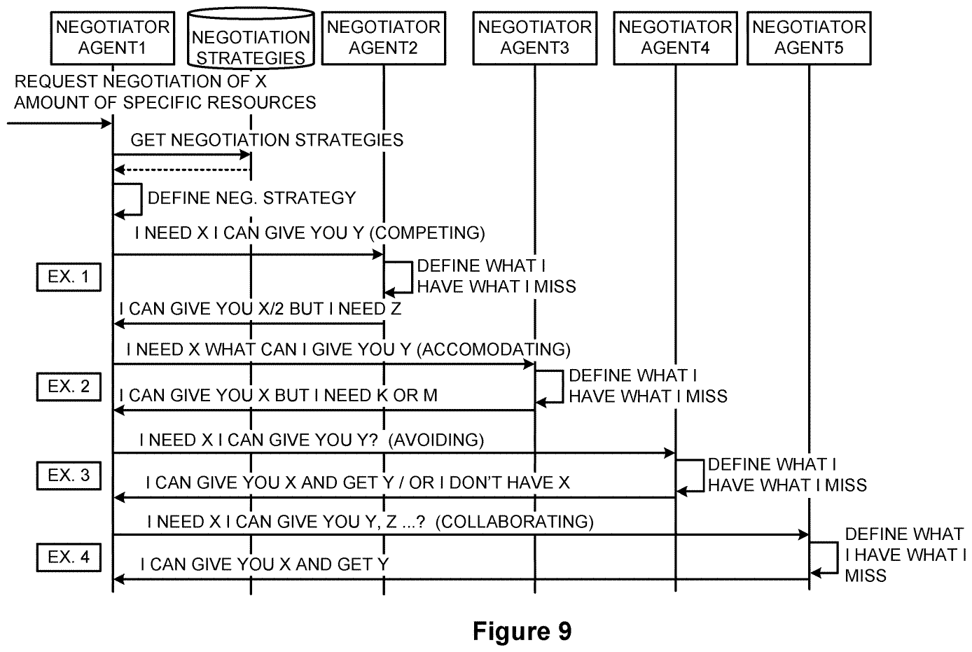

It should be noted that each selected negotiation strategy by an edge node 100 results in different behavior by the edge node 100. For instance, in the case of a competing strategy, an edge node 100 may send an offer: “I need x I can give you y”, without giving an opportunity for the receiving edge nodes to request their needs. While if the negotiation strategy is an accommodating strategy, the edge node 100 may send an offer as “I need x what can I give you?”. Hence, in the latter case, the receiver edge node 100 has the freedom to ask for an asset it is missing. FIG. 9 illustrates some examples. Specifically, example 1 is a competing strategy, example 2 is an accommodating strategy, example 3 is an avoiding strategy, and example 4 is a collaborating strategy.

It should also be noted that the training of the RL-based algorithm can be done in an offline manner. In many settings, online interaction with the environment can be impractical either because data collection is expensive or dangerous. Even in domains where online interaction is feasible, offline learning is still preferable if the domain is complex and effective generalization requires large datasets. Also, offline learning is generally a lot faster than online learning because offline learning only uses a dataset once throughout the entire model to modify weights and parameters. Hence, in such an offline setting, the training time is less of an issue compared to online settings. In addition, if we consider offline RL algorithm, the computational power required is much lower than online learning, since there is no continuous process that requires a constant input of data.

In addition, using Q-learning or SARSA can be seen as one embodiment used to explain the methods described herein. In other embodiments, Deep Q Learning (DQN) can be used. DQN can be useful when the combination of states and actions spaces is too large, also they vary over different time slots. Hence, the memory required to save and update the Q-database increases, and the computation requirement to explore each state to create Q-database will become too high. In such cases, Deep Q Network (DQN) can be expected to provide better performance by adding memory replay (a store of all previous experiences) and approximating the Q values for unmet states/actions using DNN based approach: non-linear gradient-descent function approximation.

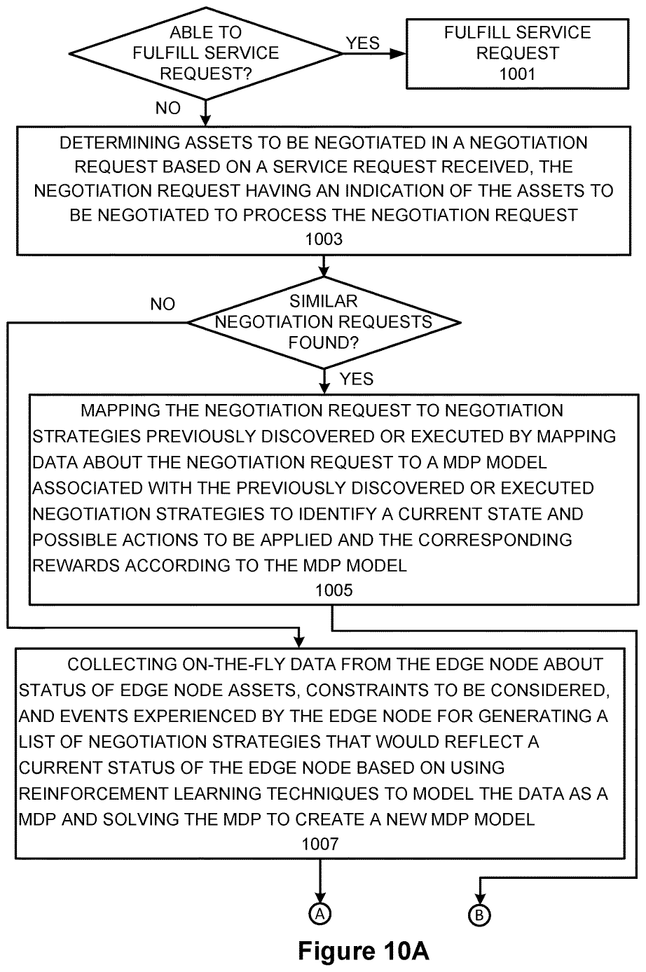

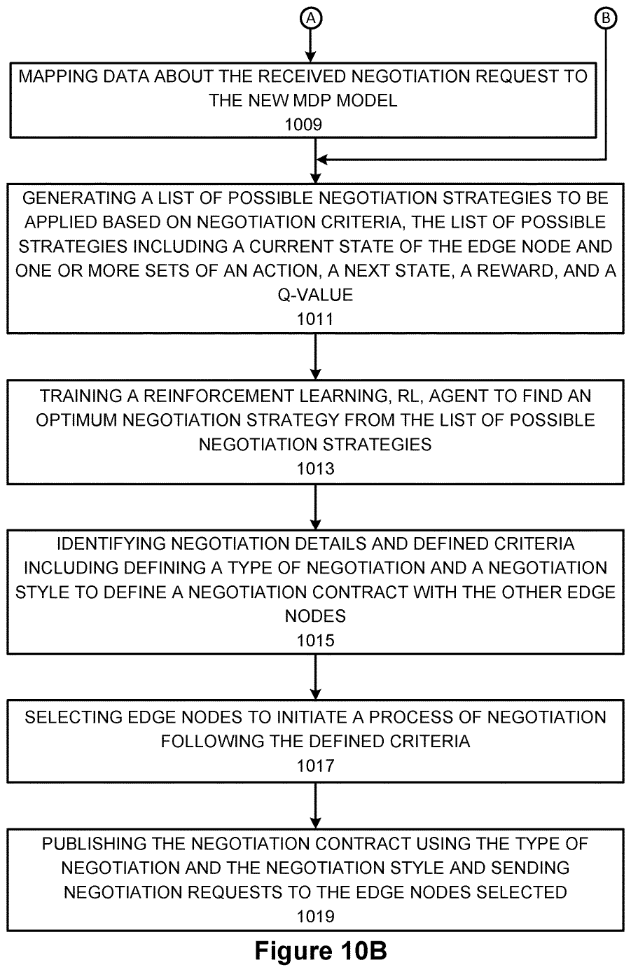

FIGS. 10A-18 illustrate operations an edge node, which shall be denoted as edge node 2000 (see FIG. 20) in the describing the various embodiments, performs to negotiate with other edge nodes in many of the various embodiments described herein. Turning to FIG. 10A, the edge node 2000 receives a service request and determines whether or not the edge node 2000 is able to fulfill the service request. In block 1001, the edge node 2000, responsive to determining that the edge node 2000 is able to fulfill requirements of the service request received, fulfills the service request. In block 1003, the edge node 2000, responsive determining that the edge node 2000 is unable to fulfill requirements of the service request received, determines assets to be negotiated in a negotiation request based on a service request received, the negotiation request having an indication of the assets to be negotiated to process the negotiation request. The identified assets may include what the edge node 2000 has and what the edge node 2000 needs. For example, the edge node 2000 may have data it can offer but needs a specific number of CPUs.

The edge node 2000 determines if there are negotiation strategies previously discovered or executed stored in a negotiation strategy repository (e.g., negotiation strategies database 106) that are similar to the negotiation request. Responsive to previously discovered or executed negotiation strategies previously discovered or executed stored in a negotiation strategy repository that are similar to the negotiation request, the edge node 2000 in block 1005 maps the negotiation request to negotiation strategies previously discovered or executed by mapping data about the negotiation request to a Markovian Decision Process, MDP, model associated with the previously discovered or executed negotiation strategies to identify a current state and possible actions to be applied and the corresponding rewards according to the MDP model.

If there are no negotiation strategies stored that are similar to the negotiation request, the edge node 2000 collects on-the-fly data from the edge node about status of edge node assets, constraints to be considered, and events experienced by the edge node for generating a list of negotiation strategies that would reflect a current status of the edge node based on using reinforcement learning techniques to model the data as a MDP and solving the MDP to create a new MDP model in block 1007.

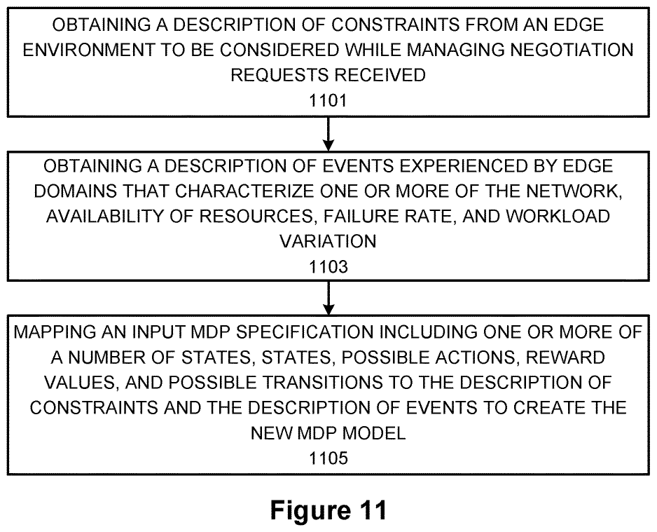

FIG. 11 illustrates one way to solve the MDP to create a new MDP model. Turning to FIG. 11, in block 1101, the edge node 2000 obtains a description of constraints from an edge environment to be considered while managing negotiation requests received. In block 1103, the edge node 2000 obtains a description of events experienced by edge domains that characterize one or more of the network, availability of resources, failure rate, and workload variation. In block 1105, the edge node 2000 maps an input MDP specification including one or more of a number of states, states, possible actions, reward values, and possible transitions to the description of constraints and the description of events to create the new MDP model.

Turning to FIG. 10B, in block 1009, the edge node 2000 maps data about the received negotiation request to the new MDP model.

In block 1011, the edge node 2000 generates a list of possible negotiation strategies to be applied based on negotiation criteria, the list of possible strategies including a current state of the edge node and one or more sets of an action, a next state, a reward, and a Q-value. In block 1013, the edge node 2000 trains a reinforcement learning, RL, agent to find an optimum negotiation strategy from the list of possible negotiation strategies.

In block 1015, the edge node 2000 identifies negotiation details and defined criteria including defining a type of negotiation and a negotiation style to define a negotiation contract with the other edge nodes. In block 1017, the edge node 2000 selects edge nodes to initiate a process of negotiation following the defined criteria. In block 1019, the edge node 2000 publishes the negotiation contract using the type of negotiation and the negotiation style and sends negotiation requests to the edge nodes selected.

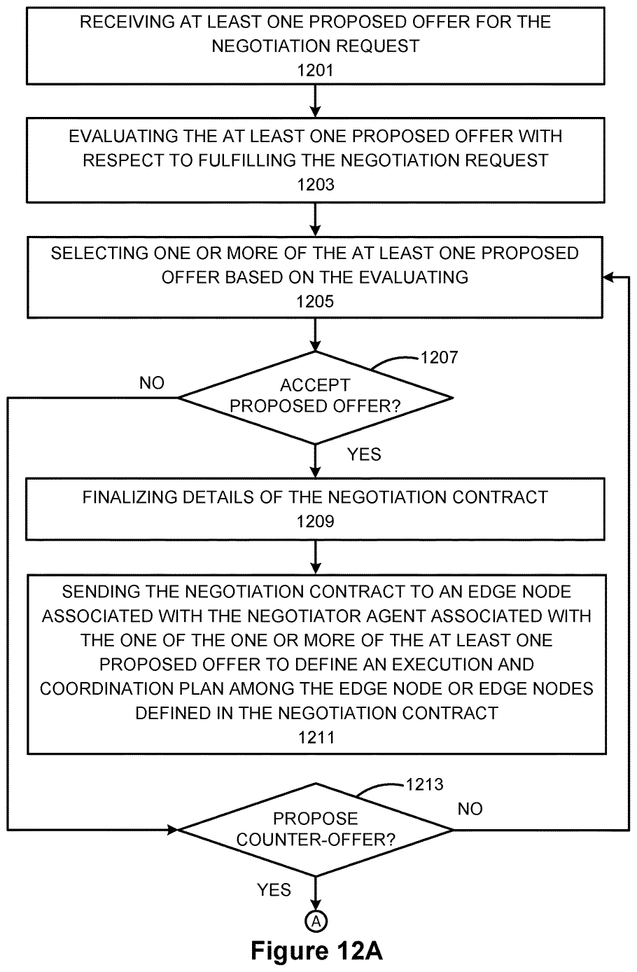

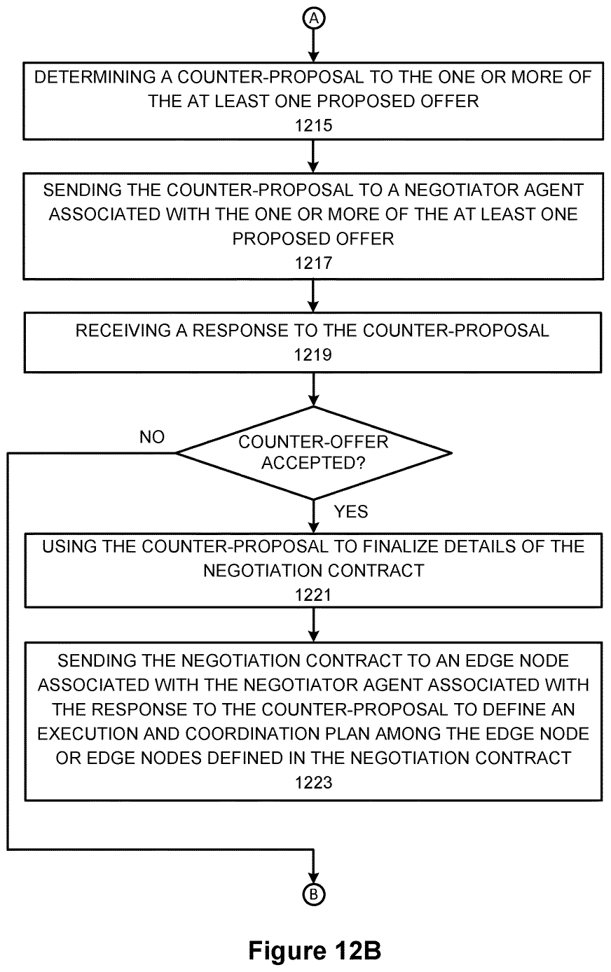

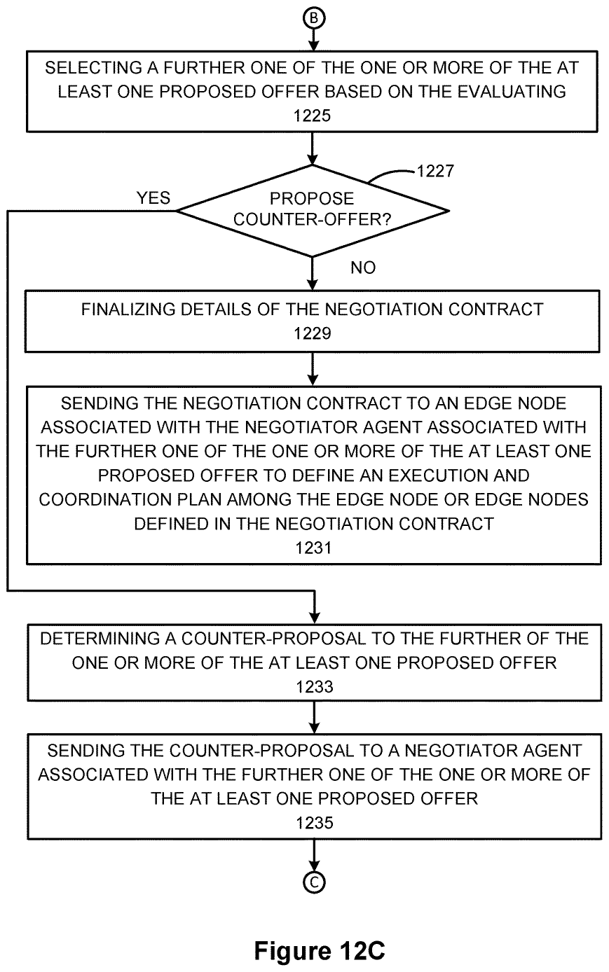

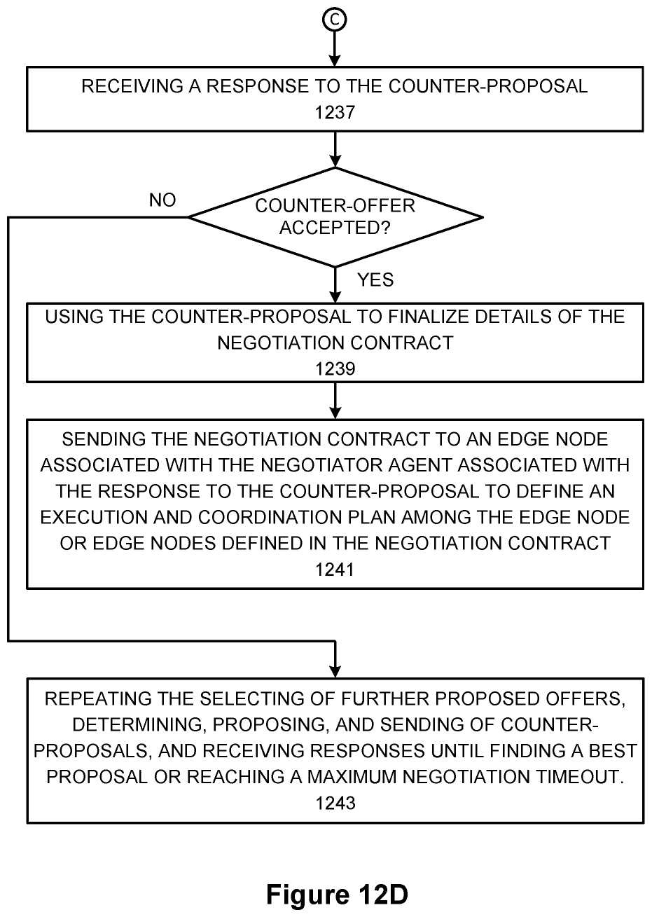

FIGS. 12A-12D illustrate operations the edge node 2000 performs in response to publishing and sending negotiation requests to the edge nodes selected.

Turning to FIG. 12A, in block 1201, the edge node 2000 receives at least one proposed offer for the negotiation request. In block 1203, the edge node 2000 evaluates the at least one proposed offer with respect to fulfilling the negotiation request as described above.

In block 1205, the edge node 2000 selects one or more of the at least one proposed offer based on the evaluating. In block 1207, the edge node 2000 determines whether or not to accept the one or more of the at least one proposed offer.

Responsive to determining to accept the one or more of the at least one proposed offer, the edge node 2000 finalizes details of the negotiation contract in block 1209 and sends the negotiation contract to an edge node associated with the negotiator agent associated with the one of the one or more of the at least one proposed offer to define an execution and coordination plan among the edge node or edge nodes defined in the negotiation contract in block 1211.

Responsive to determining not to accept the one or more of the at least one proposed offer, the edge node 2000 determines whether or not to propose a counter-proposal. Responsive to determining not to propose a counter-proposal, the edge node 2000 repeats the operations described above.

Turning to FIG. 12B, responsive to determining to propose a counter-proposal, the edge node 2000 in block 1215 determines a counter-proposal to the one or more of the at least one proposed offer. In block 1217, the edge node 2000 sends the counter-proposal to a negotiator agent associated with the one or more of the at least one proposed offer. In block 1219, the edge node 2000 receives a response to the counter-proposal.

The edge node 2000 determines whether or not the counter-proposal was accepted. Responsive to the response indicating acceptance of the counter-proposal, the edge node 2000 in block 1221 uses the counter-proposal to finalize details of the negotiation contract. In block 1223, the edge node 2000 sends the negotiation contract to an edge node associated with the negotiator agent associated with the response to the counter-proposal to define an execution and coordination plan among the edge node or edge nodes defined in the negotiation contract.

Turning to FIG. 12C, responsive to the response indicating rejection of the counter-proposal, the edge node 2000 in block 1225 selects a further one of the one or more of the at least one proposed offer based on the evaluating. For example, if the evaluating indicated another proposed offer was not as good as the one or more of the at least one proposed offer but could be accepted, then the edge node 2000 may select that proposed offer.

In block 1227, the edge node 2000 determines whether to propose a counter-proposal to the further one of the one or more of the at least one proposed offer. Responsive to determining not to propose a counter-proposal, the edge node 2000 finalizes details of the negotiation contract in block 1229 and sends the negotiation contract to an edge node associated with the further one of the one or more of the at least one proposed offer to define an execution and coordination plan among the edge node or edge nodes defined in the negotiation contract in block 1231.

Responsive to determining to propose a counter-proposal, the edge node 2000 in block 1233 determines a counter-proposal to the further one of the one or more of the at least one proposed offer. In block 1235, the edge node 2000 sends the counter-proposal to a negotiator agent associated with the further one of the one or more of the at least one proposed offer.

Turning to FIG. 12D, in block 1237, the edge node 2000 receives a response to the counter-proposal. Responsive to the response indicating acceptance of the counter-proposal, in block 1239, the edge node 2000 uses the counter-proposal to finalize details of the negotiation contract. In block 1241, the edge node 2000 sends the negotiation contract to an edge node associated with the negotiator agent associated with the response to the counter-proposal selected to define an execution and coordination plan among edge nodes defined in the negotiation contract.

Responsive to the response indicating rejection of the counter-proposal, the edge node 2000 in operation 1243 repeats the selecting of further proposed offers, determining, proposing, and sending of counter-proposals, and receiving responses until finding a best proposal or reaching a maximum negotiation timeout. In other words, the edge node repeats operations 1201-1243 until the edge node 2000 accepts a proposed offer or response to a counter-proposal or a maximum negotiation timeout occurs.

In some embodiments, when a maximum negotiation timeout occurs, the edge node 2000 may inform the user to determine what the user wants to do. For example, the user may want to repeat the negotiation request with the same identified assets or with different identified assets to the same edge nodes or to different edge nodes, not do anything, etc.

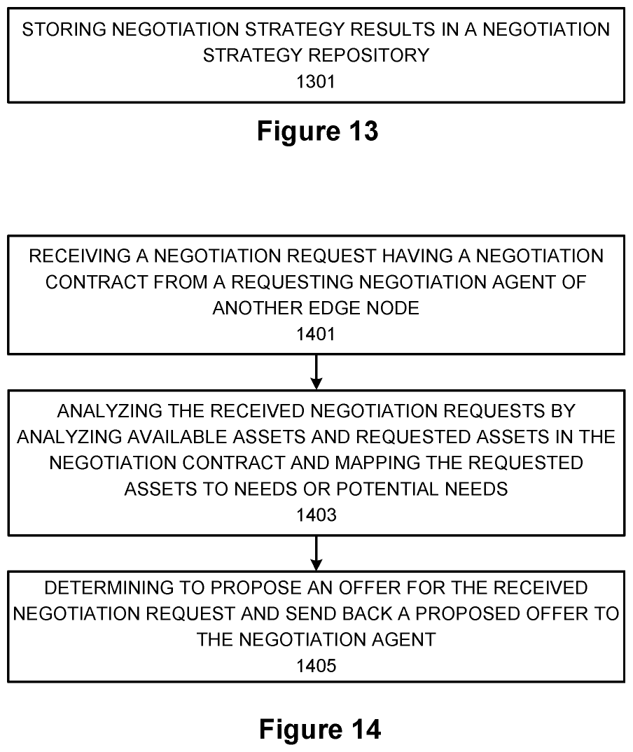

The edge node 2000 stores the negotiation strategy results (with an identification of the negotiation strategy used) in the negotiation strategy repository 106 as illustrated in block 1301 of FIG. 13.

FIGS. 14-17 illustrate operations an edge node 2000 performs when receiving a negotiation request. Turning to FIG. 14, in block 1401, the edge node 2000 receives a negotiation request having a negotiation contract from a requesting negotiation agent of another edge node. In block 1403, the edge node 2000 analyzes the received negotiation requests by analyzing available assets and requested assets in the negotiation contract and mapping the requested assets to needs or potential needs. In block 1405, the edge node 2000 determines to propose an offer for the received negotiation request and send back a proposed offer to the negotiation agent.

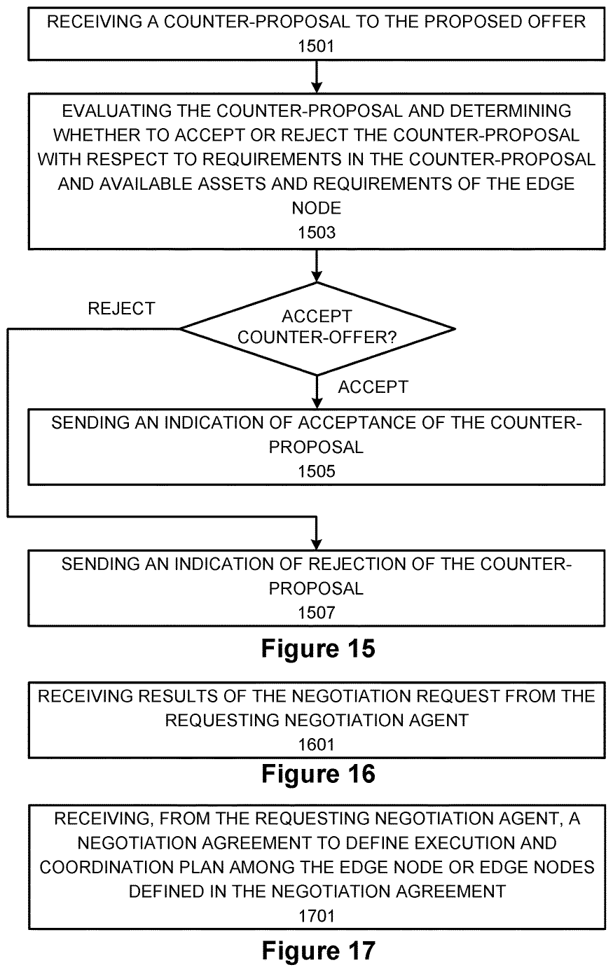

Turning to FIG. 15, in block 1501, the edge node 2000 receives a counter-proposal to the proposed offer. In block 1503, the edge node 2000 evaluates the counter-proposal and determines whether to accept or reject the counter-proposal with respect to requirements in the counter-proposal and available assets and requirements of the edge node 2000. Responsive to determining to accept the counter-proposal, the edge node 2000 in block 1505 sends an indication of acceptance of the counter-proposal. Responsive to determining to reject the counter-proposal, the edge node 2000 in block 1507 sends an indication of rejection of the counter-proposal.

In some embodiments, the edge node 2000 may receive results of the negotiation request when the edge node 2000 was not selected. This is illustrated in block 1601 of FIG. 16 where the edge node 2000 receives results of the negotiation request from the requesting negotiation agent.

Turning to FIG. 17, in block 1701, the edge node 2000 receives, from the requesting negotiation agent, a negotiation agreement to define execution and coordination plan among the edge node or edge nodes defined in the negotiation agreement. This indicates that the proposed offer of the edge node 2000 or the counter-proposal response was accepted by the requesting negotiation agent of the other edge node.

The various embodiments described herein provide a solution for applications to run in the most appropriate infrastructure environment. They automatically manage and negotiate different types of assets between edge nodes allowing efficient cooperation between them and generate adaptive negotiation strategies using ML models according to the status of the edge nodes and applications/user specifications. They also provide continuous learning and building of a knowledge-based repository about negotiation strategies between edge nodes and their results. Using such an RL-based approach to generate adaptive negotiation strategies on the fly cannot be achieved by naïve and conventional techniques, considering the scale, complexity, and dynamicity of edge nodes, application requirements, application constraints, and user specifications.

The various embodiments may be deployed in different edge and cloud environments because they do not depend on a specific type of cloud or edge where they could be deployed or a specific type of application to start the assets management and negotiation. Moreover, the self-learning solution adapts its decisions according to the status of the available assets (e.g., resources, data, knowledge, etc.) in the edge-cloud system. As an example, a Network Functions Virtualization Infrastructure (NFVI) is a potential product where the various embodiments may be deployed to test a solution.

For instance, NFVI is a cloud platform where different applications (OSS (operations support systems), BSS (business support systems), media, etc.) are running and may require different assets from several edge nodes. The performance of these applications relies on how the computation will be processed and how the assets are coordinated between different edge-cloud domains. Therefore, there is a need for the embodiments of the present disclosure to coordinate edge assets and manage the negotiation strategies taken by different domains, these adaptive strategies consider the specification of the applications running in the NFVI environment and their corresponding users. As a result, it could improve the business value associated with the OSS and BSS operations or it may align the operations with given business input/target specified by the user.

Thus, a system and methods that can negotiate and manage edge cloud assets (e.g., resources, capabilities, data, knowledge, etc.) on the fly according to the application requirements and the assets possessed by edge nodes has been described. The system includes a request analyzer that:
receives an application request,
analyzes the request to decide if the given edge node can fulfill the requirements of the request,
triggers the negotiation process to start negotiation with other edge nodes in order to fulfill the application request's requirements.
   The system also includes a negotiation agent which on receiving a negotiation request:
generates negotiation strategies of edge assets (e.g., resources, capabilities, data, knowledge, etc.) based on events detected in the edge environment using ML models,
defines a negotiation contract: negotiation type and negotiation strategy,
publishes the negotiation details to other edge nodes,
evaluates and proposes negotiation offers,
evaluates the received offer and decides whether to accept, reject, or offer counterproposals,
finalizes the negotiation agreement,
stores historical data about negotiation agreements and strategies.

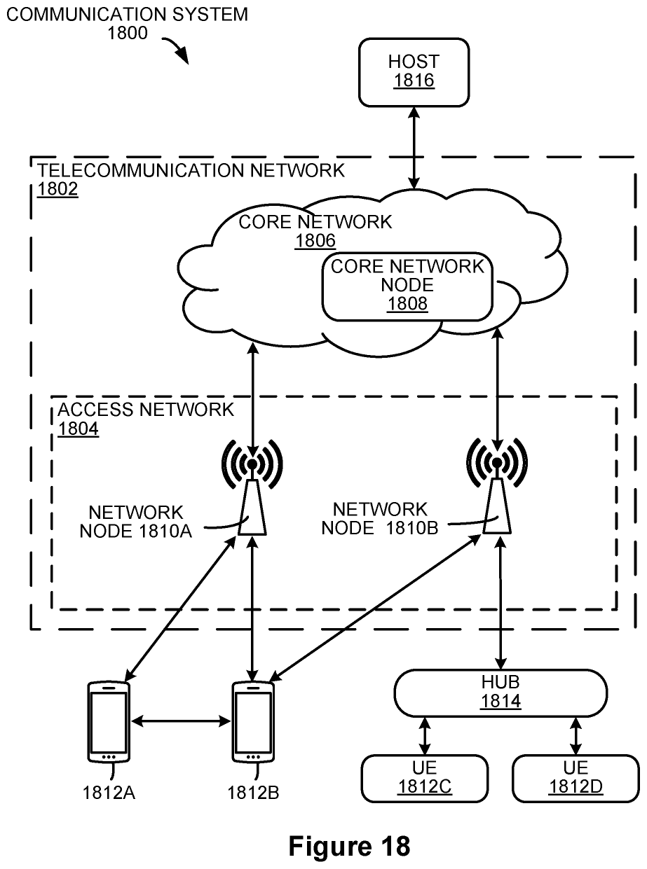

FIG. 18 shows an example of a communication system 1800 in accordance with some embodiments.

In the example, the communication system 1800 includes a telecommunication network 1802 that includes an access network 1804, such as a radio access network (RAN), and a core network 1806, which includes one or more core network nodes 1808. The access network 1804 includes one or more access network nodes, such as network nodes 1810A and 1810B (one or more of which may be generally referred to as network nodes 1810), or any other similar 3^{rd} Generation Partnership Project (3GPP) access node or non-3GPP access point. The network nodes 1810 facilitate direct or indirect connection of user equipment (UE), such as by connecting UEs 1812A, 1812B, 1812C, and 1812D (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi (Light Fidelity), and/or any low-power wide-area network (LPWAN) standards such as LoRa (Long Range) and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT (Internet of Things) services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1814 communicates with the access network 1804 to facilitate indirect communication between one or more UEs (e.g., UE 1812C and/or 1812D) and network nodes (e.g., network node 1810B). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810B. The hub 1814 may also allow for a different communication scheme and/or schedule between the hub 1814 and UEs (e.g., UE 1812C and/or 1812D), and between the hub 1814 and the core network 1806. In other examples, the hub 1814 is connected to the core network 1806 and/or one or more UEs via a wired connection. Moreover, the hub 1814 may be configured to connect to an M2M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810B. In other embodiments, the hub 1814 may be a non-dedicated hub—that is, a device which is capable of operating to route communications between the UEs and network node 1810B, but which is additionally capable of operating as a communication start and/or end point for certain data channels.

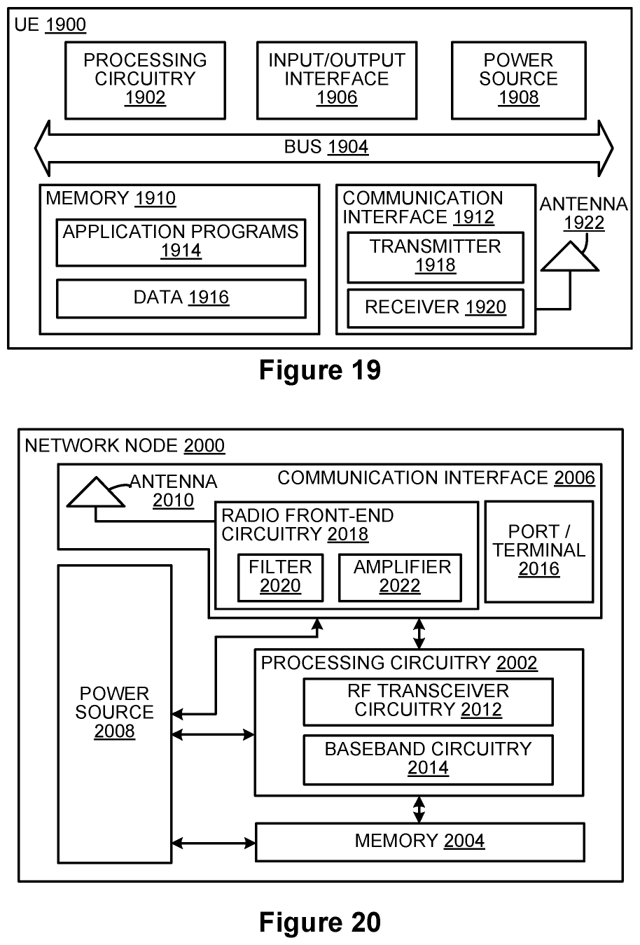

FIG. 19 shows a UE 1900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1902 may include multiple central processing units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging of the power source 1908. Power circuitry may perform any formatting, converting, or other modification to the power from the power source 1908 to make the power suitable for the respective components of the UE 1900 to which power is supplied.

The memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

In the illustrated embodiment, communication functions of the communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), edge nodes, base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes a processing circuitry 2002, a memory 2004, a communication interface 2006, and a power source 2008. The network node 2000 may be composed of multiple physically separate components (e.g., a NodeB component and a RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the radio frequency (RF) transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

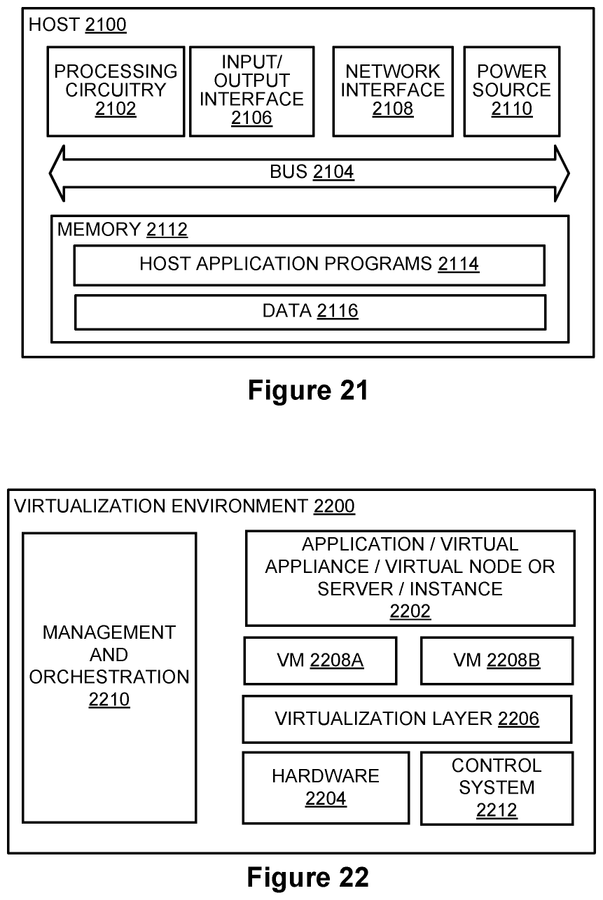

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000. FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment 2200 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208A and 2208B (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g., such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

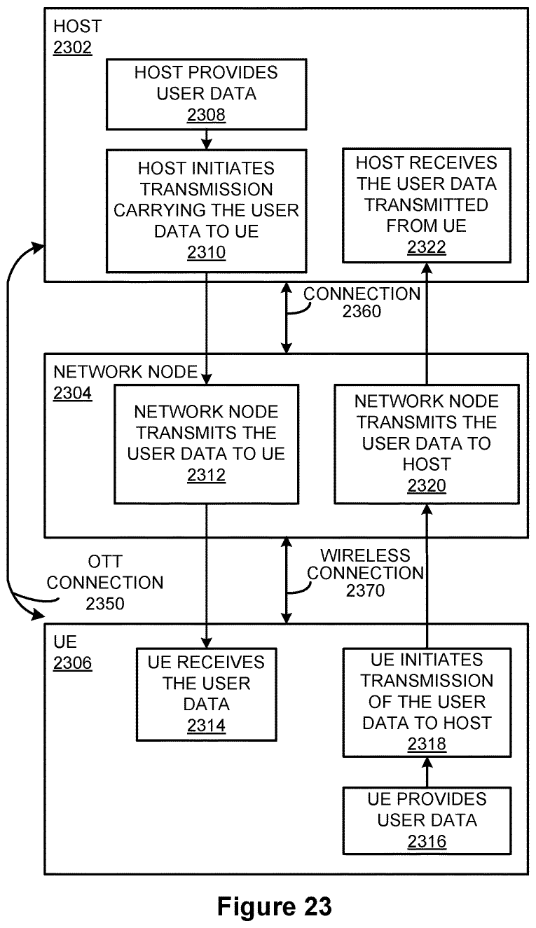

FIG. 23 shows a communication diagram of a host 2302 communicating via a network node 2304 with a UE 2306 over a partially wireless connection in accordance with some embodiments. Example implementations, in accordance with various embodiments, of the UE (such as a UE 1812A of FIG. 18 and/or UE 1900 of FIG. 19), network node (such as network node 1810A of FIG. 18 and/or network node 2000 of FIG. 20), and host (such as host 1816 of FIG. 18 and/or host 2100 of FIG. 21) discussed in the preceding paragraphs will now be described with reference to FIG. 23.

Like host 2100, embodiments of host 2302 include hardware, such as a communication interface, processing circuitry, and memory. The host 2302 also includes software, which is stored in or accessible by the host 2302 and executable by the processing circuitry. The software includes a host application that may be operable to provide a service to a remote user, such as the UE 2306 connecting via an over-the-top (OTT) connection 2350 extending between the UE 2306 and host 2302. In providing the service to the remote user, a host application may provide user data which is transmitted using the OTT connection 2350.

The network node 2304 includes hardware enabling it to communicate with the host 2302 and UE 2306. The connection 2360 may be direct or pass through a core network (like core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by UE 2306 and executable by the UE's processing circuitry. The software includes a client application, such as a web browser or operator-specific “app” that may be operable to provide a service to a human or non-human user via UE 2306 with the support of the host 2302. In the host 2302, an executing host application may communicate with the executing client application via the OTT connection 2350 terminating at the UE 2306 and host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via a connection 2360 between the host 2302 and the network node 2304 and via a wireless connection 2370 between the network node 2304 and the UE 2306 to provide the connection between the host 2302 and the UE 2306. The connection 2360 and wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304, in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR or AR which it can broadcast, multicast or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2350 between the host 2302 and UE 2306, in response to variations in the measurement results. The measurement procedure and/or the network functionality for reconfiguring the OTT connection may be implemented in software and hardware of the host 2302 and/or UE 2306. In some embodiments, sensors (not shown) may be deployed in or in association with other devices through which the OTT connection 2350 passes; the sensors may participate in the measurement procedure by supplying values of the monitored quantities exemplified above, or supplying values of other physical quantities from which software may compute or estimate the monitored quantities. The reconfiguring of the OTT connection 2350 may include message format, retransmission settings, preferred routing etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency and the like, by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method in an edge node of a network to negotiate with other edge nodes, the method comprising:
responsive to the edge node determining that the edge node is unable to fulfill requirements of a service request received, determining assets to be negotiated in a negotiation request based on a service request received, the negotiation request having an indication of the assets to be negotiated to process the negotiation request;
responsive to previously discovered or executed negotiation strategies stored in a negotiation strategy repository that are similar to the negotiation request, mapping the negotiation request to negotiation strategies previously discovered or executed by:
mapping data about the negotiation request to a Markovian Decision Process, MDP, model associated with the previously discovered or executed negotiation strategies to identify a current state and possible actions to be applied and the corresponding rewards according to the MDP model;
responsive to no negotiation strategies similar to the negotiation request being found:
collecting on-the-fly data from the edge node about status of edge node assets, constraints to be considered, and events experienced by the edge node for generating a list of negotiation strategies that would reflect a current status of the edge node based on using reinforcement learning techniques to model the data as a MDP and solving the MDP to create a new MDP model; and
mapping data about the received negotiation request to the new MDP model;
generating a list of possible negotiation strategies to be applied based on negotiation criteria, the list of possible strategies including a current state of the edge node and one or more sets of an action, a next state, a reward, and a Q-value;
training a reinforcement learning, RL, agent to find an optimum negotiation strategy from the list of possible negotiation strategies;
identifying negotiation details and defined criteria including defining a type of negotiation and a negotiation style to define a negotiation contract with the other edge nodes;
selecting edge nodes to initiate a process of negotiation following the defined criteria; and
publishing the negotiation contract using the type of negotiation and the negotiation style and sending negotiation requests to the edge nodes selected.

2. (canceled)

3. The method of claim 1, wherein solving the MDP to create the new MDP model comprises:
obtaining a description of constraints from an edge environment to be considered while managing negotiation requests received;
obtaining a description of events experienced by edge domains that characterize one or more of the network, availability of resources, failure rate, and workload variation;
mapping an input MDP specification including one or more of a number of states, states, possible actions, reward values, and possible transitions to the description of constraints and the description of events to create the new MDP model.

4. The method of claim 1, further comprising:
receiving at least one proposed offer for the negotiation request;
evaluating the at least one proposed offer with respect to fulfilling the negotiation request;
selecting one or more of the at least one proposed offer based on the evaluating;
determining whether or not to accept the one or more of the at least one proposed offer;
responsive to determining to accept the one or more of the at least one proposed offer:
finalizing details of the negotiation contract; and
sending the negotiation contract to an edge node associated with the negotiator agent associated with the one or more of the at least one proposed offer to define an execution and coordination plan among the edge node or edge nodes defined in the negotiation contract; and
responsive to determining not to accept the one or more of the at least one proposed offer, determining whether or not to propose a counter-proposal.

5. The method of claim 4, further comprising:
determining a counter-proposal to the one or more of the at least one proposed offer; and
sending the counter-proposal to a negotiator agent associated with the one or more of the at least one proposed offer; and
receiving a response to the counter-proposal.

6. The method of claim 5, further comprising:
responsive to the response indicating acceptance of the counter-proposal, using the counter-proposal to finalize details of the negotiation contract; and
sending the negotiation contract to an edge node associated with the negotiator agent associated with the response to the counter-proposal to define an execution and coordination plan among the edge node or edge nodes defined in the negotiation contract.

7. The method of claim 5, further comprising:
responsive to the response indicating rejection of the counter-proposal, selecting a further one of the one or more of the at least one proposed offer based on the evaluating;
determining whether to propose a counter-proposal to the further one of the one or more of the at least one proposed offer;
responsive to determining not to propose a counter-proposal, finalizing-(1329) details of the negotiation contract; and
sending the negotiation contract to an edge node associated with the further one of the one or more of the at least one proposed offer to define an execution and coordination plan among the edge node or edge nodes defined in the negotiation contract.

8. The method of claim 7, further comprising:
responsive to determining to propose a counter-proposal, determining a counter-proposal to the further one of the one or more of the at least one proposed offer; and
sending the counter-proposal to a negotiator agent associated with the further one of the one or more of the at least one proposed offer; and
receiving a response to the counter-proposal.

9. The method of claim 8, further comprising responsive to the response indicating acceptance of the counter-proposal, using the counter-proposal to finalize details of the negotiation contract; and
sending the negotiation contract to an edge node associated with the negotiator agent associated with the response to the counter-proposal selected to define an execution and coordination plan among edge nodes defined in the negotiation contract.

10. The method of claim 8, further comprising:
responsive to the response indicating rejection of the counter-proposal, repeating the selecting of further proposed offers, determining, proposing, and sending of counter-proposals, and receiving responses until finding a best proposal or reaching a maximum negotiation timeout.

11. The method of claim 1, further comprising storing negotiation strategy results in a negotiation strategy repository.

12. The method of claim 1, further comprising:
receiving a negotiation request having a negotiation contract from a requesting negotiation agent of another edge node;
analyzing the received negotiation requests by analyzing available assets and requested assets in the negotiation contract and mapping the requested assets to needs or potential needs;
determining to propose an offer for the received negotiation request and send back a proposed offer to the negotiation agent.

13. The method of claim 12, further comprising:
receiving a counter-proposal to the proposed offer;
evaluating the counter-proposal and determining whether to accept or reject the counter-proposal with respect to requirements in the counter-proposal and available assets and requirements of the edge node;
responsive to determining to accept the counter-proposal, sending an indication of acceptance of the counter-proposal; and
responsive to determining to reject the counter-proposal, sending an indication of rejection of the counter-proposal.

14. The method of claim 12, further comprising:
receiving results of the negotiation request from the requesting negotiation agent.

15. The method of claim 12, further comprising:
receiving, from the requesting negotiation agent, a negotiation agreement to define execution and coordination plan among the edge node or edge nodes defined in the negotiation agreement.

16-19. (canceled)

20. A computer program comprising program code to be executed by processing circuitry of an edge node, whereby execution of the program code causes the edge node to perform operations comprising:
responsive to the edge node determining that the edge node is unable to fulfill requirements of a service request received, determining assets to be negotiated in a negotiation request based on a service request received, the negotiation request having an indication of the assets to be negotiated to process the negotiation request;
responsive to previously discovered or executed negotiation strategies stored in a negotiation strategy repository that are similar to the negotiation request, mapping the negotiation request to negotiation strategies previously discovered or executed by:
mapping data about the negotiation request to a Markovian Decision Process, MDP, model associated with the previously discovered or executed negotiation strategies to identify a current state and possible actions to be applied and the corresponding rewards according to the MDP model;
responsive to no negotiation strategies being found:
collecting on-the-fly data from the edge node about status of edge node assets, constraints to be considered, and events experienced by the edge node to generate a list of negotiation strategies that would reflect a current status of the edge node based on using reinforcement learning techniques to model the data as a MDP and solving the MDP to create a new MDP model; and
mapping data about the received negotiation request to the new MDP model generating a list of possible negotiation strategies to be applied based on negotiation criteria, the list of possible strategies including a current state of the edge node and one or more sets of an action, a next state, a reward, and a Q-value;
training a reinforcement learning, RL, agent to find an optimum negotiation strategy from the list of possible negotiation strategies;
identifying negotiation details and defined criteria including defining a type of negotiation and a negotiation style to define a negotiation contract with the other edge nodes;
selecting edge nodes to initiate a process of negotiation following the defined criteria; and
publishing the negotiation contract using the type of negotiation and the negotiation style and sending negotiation requests to the edge nodes selected.

21. The computer program of claim 20 comprising further program code, whereby execution of the program code causes the edge node to negotiate with other edge nodes, the method comprising:
responsive to the edge node determining that the edge node is unable to fulfill requirements of a service request received, determining assets to be negotiated in a negotiation request based on a service request received, the negotiation request having an indication of the assets to be negotiated to process the negotiation request;
responsive to previously discovered or executed negotiation strategies stored in a negotiation strategy repository that are similar to the negotiation request, mapping the negotiation request to negotiation strategies previously discovered or executed by:
mapping data about the negotiation request to a Markovian Decision Process, MDP, model associated with the previously discovered or executed negotiation strategies to identify a current state and possible actions to be applied and the corresponding rewards according to the MDP model;
responsive to no negotiation strategies similar to the negotiation request being found:
collecting on-the-fly data from the edge node about status of edge node assets, constraints to be considered, and events experienced by the edge node for generating a list of negotiation strategies that would reflect a current status of the edge node based on using reinforcement learning techniques to model the data as a MDP and solving the MDP to create a new MDP model; and
mapping data about the received negotiation request to the new MDP model;
generating a list of possible negotiation strategies to be applied based on negotiation criteria, the list of possible strategies including a current state of the edge node and one or more sets of an action, a next state, a reward, and a Q-value;
training a reinforcement learning, RL, agent to find an optimum negotiation strategy from the list of possible negotiation strategies;
identifying negotiation details and defined criteria including defining a type of negotiation and a negotiation style to define a negotiation contract with the other edge nodes;
selecting edge nodes to initiate a process of negotiation following the defined criteria; and
publishing the negotiation contract using the type of negotiation and the negotiation style and sending negotiation requests to the edge nodes selected, further comprising: responsive to the edge node determining that the edge node is able to fulfill requirements of the service request received, fulfilling the service request.

22-23. (canceled)
